(19) United States
(12) Patent Application Publication
(10) Pub. No.: US 2008/0151048 A1
(43) Pub. Date: Jun. 26, 2008

(54) Driving supporting apparatus

(75) Inventors: Takashi Watanabe, Utsunomiya-shi (JP); Yoshiyuki Matsumoto, Utsunomiya-shi (JP); Kei Oshida, Utsunomiya-shi (JP); Yoichi Sugimoto, Utsunomiya-shi (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/823,365

(22) Filed: Jun. 27, 2007

(30) Foreign Application Priority Data
Nov. 7, 2006 (JP) P 2006-190286

(51) Int. Cl. H04N 7/18

(52) U.S. Cl. 348/143; 348/E07.085

(57) ABSTRACT

A driving support apparatus includes: an image sensing device that is provided in a vehicle, and is able to photograph a rearward region of the vehicle, and a dead angle region that is adjacent to the rearward region and cannot be perceived by a driver with a side mirror; and a display unit that displays video images photographed by the image sensing device so as to be visible to the driver, wherein a predetermined region of the video image photographed by the image sensing device is displayed in an enlarged form.

### BACKGROUND OF THE INVENTION

Priority is claimed on Japanese Patent Application No. 2006-190286, filed Jul. 11, 2006, the content of which is incorporated herein by reference.

1. Field of the Invention

The present invention relates to a driving support apparatus for a vehicle.

2. Description of Related Art

Generally, side mirrors (for example, door mirrors) that enable a driver to view a rearward region of a vehicle in order to confirm the safety of an operation are provided on a vehicle.

Moreover, recently, monitor systems (see, for example, Japanese Unexamined Patent Application, First Publication Nos. H09-71198 and H11-5501) have become widely used that photograph the rearward of a vehicle using a camera and display the images on an in-vehicle monitor.

In these monitor systems, in order to more reliably perform a safety check of the rearward region, in addition to the regions that are viewable using conventional side mirrors, attempts have been made to display on the monitor dead angle regions that cannot be viewed with the side mirrors. In this case, it is necessary to use a camera that is provided with a wide-angle lens having such an angle of view as to photograph a greater angular range of, for example, 50 degrees or more than the angular range that can be viewed with side mirrors.

When a vehicle is present in the rearward region, if the rearward region is photographed by a camera and displayed on the monitor at the same angular range as the angular range that can be viewed with side mirrors, then the image of the vehicle that is displayed on the monitor and the image of the vehicle that is reflected in the side mirrors appear to the driver to be substantially the same size. Therefore, the driver feels little sense of discomfort. In contrast, if wide-angle video images of the rearward region that have been photographed using the camera provided with a wide-angle lens are displayed unmodified on the monitor, then a driver watching the monitor feels that the vehicle is positioned farther away than it actually is, because the images of the vehicle that are displayed on the monitor appear smaller to the driver than the images of the vehicle that are reflected in the side mirrors.

Moreover, because the image of the vehicle that is displayed on the monitor appears smaller in comparison with the image of a vehicle in a rearward region that is reflected in the side mirrors, when both the side mirrors and the monitor are used at the same time, the driver feels a sense of discomfort and finds it hard to obtain a true sense of the distance to the vehicle in the rearward region.

Therefore, the present invention has an object to provide a driving support apparatus that makes it possible for the driver to perform a more reliable safety check of the rearward region of a vehicle without the driver feeling any sense of discomfort when a driver is using side mirrors in conjunction with a monitor.

### SUMMARY OF THE INVENTION

In order to solve the above-described problems, the present invention employs the followings.

Namely, a driving support apparatus includes: an image sensing device that is provided in a vehicle, and is able to photograph a rearward region of the vehicle and photograph a dead angle region that is adjacent to the rearward region and cannot be perceived by a driver with a side mirror; and a display unit that displays video images photographed by the image sensing device so as to be visible to the driver, wherein a predetermined region of the video image photographed by the image sensing device is displayed in a enlarged form.

According to the above-described driving support apparatus, because the display unit is able to display an enlargement of an object present in the predetermined region, the driver is able to reliably view the object via the display unit.

It may be arranged such that the predetermined region corresponds to the rearward region.

In this case, because the display unit is able to display an enlargement of an object present in the rearward region, the driver is able to reliably view the object via the display unit.

It may be arranged such that an enlargement ratio of the predetermined region of the video image can be changed in each unit display region that makes up the video image.

In this case, because the display unit is able to smoothly join video images of the predetermined region that are displayed in an enlarged form with video images other than the predetermined region, the driver experiences no sense of discomfort.

It may be arranged such that the enlargement ratio increases the farther away it is from the dead angle region.

In this case, because the display unit is able to smoothly join video images of the predetermined region that are displayed in an enlarged form with video images of the dead angle region, the driver experiences no sense of discomfort.

It may be arranged such that the display unit displays the dead angle region of the video image in a reduced form in the vehicle width direction.

In this case, because the display unit is able to display photographed video images without leaving out video images of the dead angle region, the driver is able to reliably view an object present in the dead angle region via the display unit.

It may be arranged such that the reduction ratio of the dead angle region of the video image decreases the closer it is to the predetermined region.

In this case, because video images of the dead angle region and the predetermined region that are displayed on the display unit are smoothly connected, the driver experiences no sense of discomfort.

It may be arranged such that the enlargement ratio is set such that the size of an image of an object in the predetermined region displayed by the display unit is substantially the same as the size of an image of the object that is perceived by the driver in the side mirror.

In this case, because an object that is present within the predetermined region is displayed in images having substantially the same size in both the side mirror and the display unit, the driver experiences no sense of discomfort when viewing both the side mirror and the display unit. More specifically, for example, when views of the side mirror and the display unit are compared, the sense of distance to the object experienced by the driver is substantially the same in each case. Accordingly, the driver is able to make a more reliable safety check of the rearward region.

It may be arranged such that the image sensing device is able to photograph a region that includes a portion of a body of the vehicle, and the display unit displays a video image such that an enlargement ratio of the region that includes the portion of the vehicle body is smaller than the enlargement ratio of the predetermined region in the vehicle width direction.

In this case, because the driver is able to view a portion of the body of the vehicle via the display unit, the relative positional relationship between the present vehicle and the object can be ascertained.

### BRIEF DESCRIPTION OF THE DRAWINGS

FIG. 1 is a structural view of a driving support apparatus according to an embodiment of the present invention.

FIG. 2 is a block diagram of the driving support apparatus according to the embodiment.

FIG. 3 is an explanatory view showing ranges that can be viewed by door mirrors and an object detection region of an external sensor, of the driving support apparatus according to the embodiment.

FIG. 4 is a view showing an image that is reflected in a left door mirror of the driving support apparatus according to the embodiment.

FIG. 5 is a view showing a monitor video image prior to image processing, and the angle of view in each unit display region of the monitor image in the driving support apparatus according to the embodiment.

FIG. 6 is a view showing a monitor video image subsequent to image processing, and the angle of view in each unit display region of the monitor image in the driving support apparatus according to the embodiment.

FIG. 7 is an explanatory view showing a relationship between an object detection region of an external camera and an angle of view in the driving support apparatus according to the embodiment.

FIG. 8 is a flow chart showing image switching processing in the driving support apparatus according to the embodiment.

### DETAILED DESCRIPTION OF THE INVENTION

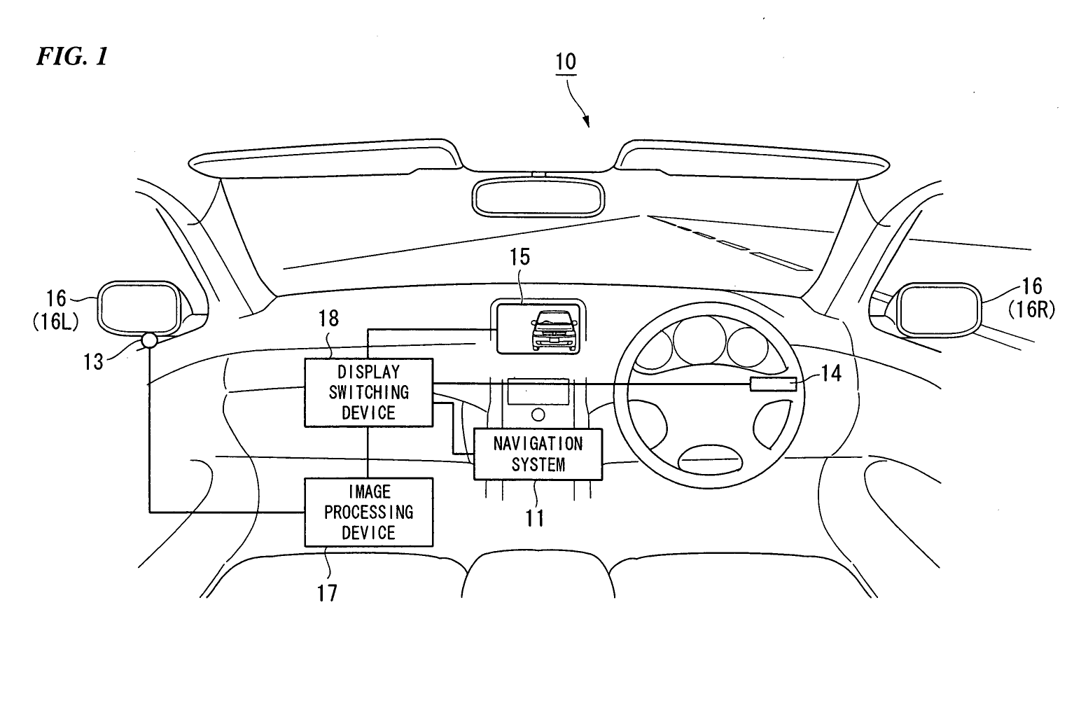

The driving support apparatus according to an embodiment of the present invention will now be described below with reference to FIG. 1 through FIG. 8.

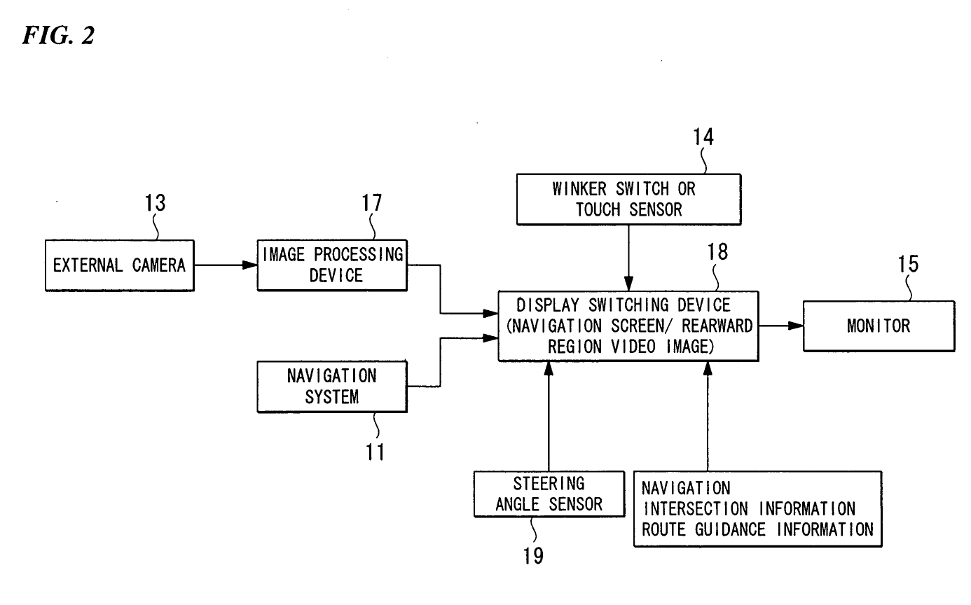

As is shown in, for example, FIG. 1 and FIG. 2, a driving support apparatus 10 of the present embodiment includes a navigation system 11, an external camera (i.e., an image sensing device) 13, a monitor (i.e., a display unit) 15, door mirrors (i.e., side mirrors) 16, an image processing device 17, and a display switching device 18.

They navigation system 11 determines the current position and traveling direction of a vehicle based on measured results of positioning signals such as GPS (global positioning system) signals that are used to measure the position of a vehicle using artificial satellites, or based on various measured results from vehicle quantity of state sensors that measure vehicle quantities of state (for example, acceleration sensors that measure an acceleration of a vehicle and a steering angle sensor 19 that measures a steering wheel angle of the vehicle). In addition, based on the results of such determinations, the navigation system 11 performs map matching processing on map data stored in a map data storage device so as to enable it to control a display position which shows the current position of the present vehicle on a display screen, and to control map-displays on a display screen in accordance with the detected current position of the present vehicle or the appropriate vehicle position input by an operator via some type of switch or keyboard or the like.

The map data storage device installed in the navigation system 11 is provided with map data in the form of data needed for processing such as route searching and route guidance (for example, various data such as nodes which are points composed of the latitude and longitude of predetermined positions such as intersection points and the like, and links which are lines connecting the respective nodes) as well as data used to display maps on the display screen of the navigation system 11 and road coordinate data that is required for map matching processing which is based on the vehicle's current position. Furthermore, various types of information such as, for example, latitudes and longitudes that show the positions of the intersections, intersection information related to the existence or otherwise of traffic signals and the configuration and intersection angles of roads and the like, information on road types (for example, national roads, provincial roads, local roads and the like), road width information (for example, width data and the like), and road structure information (for example, number of vehicle lanes, forks, merges, and the like) are attached to the nodes and links.

The navigation system 11 outputs navigation image data to the display switching device 18.

The external camera 13 includes a CCD camera or CMOS camera or the like that is able to pick up images, for example, in the visible light region or infrared light region, and may be positioned at, for example, the lower part of at least one of the left and right door mirrors 16 (for example, the left door mirror 16L).

An example in which the external camera 13 is placed at the lower part of the left door mirror 16L will now be described below. The external camera 13 is provided with a wide-angle lens and photographs an external predetermined wide-angle region (for example, at a viewing angle of 82°) which is from the left side region to the rear region of a present vehicle, and also performs predetermined image processing such as, for example, filtering and binarization processing on the images which are obtained by this photography. The external sensor 13 then creates image data which consists of pixels in a two-dimensional array and outputs these to the image processing device 17.

The image processing device 17 performs enlargement and/or reduction processing on image data input from the external camera 13, and outputs the image data to the display switching device 18. The image processing performed by the image processing device 17 is described in detail later.

The monitor 15 may include, for example, a 5 to 8 inch liquid crystal display unit that is installed in the navigation system 11, and is provided in a position where it is visible to a driver (for example, a substantially central position in the vehicle width direction of the instrument panel).

The display switching device 18 determines whether to display navigation images input from the navigation system 11 or whether to display external video images (i.e., video images of the rearward region) input from the image processing device 17. For example, the display switching device 18 determines whether or not a state exists in which video images of the rearward region are required. If it is determined that they are not required the display switching device 18 displays navigation images on the monitor 15, while if it is determined that they are required the display switching device 18 displays video images of the rearward region.

For example, when an operation of a winker switch 14 or a touch to the winker switch 14 by the driver is detected with the winker switch 14 or a touch sensor that is provided on a surface of the winker switch 14, or when a steering wheel angle of a predetermined value or more is detected by the steering angle sensor 19, it is determined that the driver has an intention of changing lanes, turning left or right, or the like. Alternatively, it is determined that the present vehicle is actually in the process of changing lanes or executing a left or right turn. In these cases, the display switching device 18 determines that a state exists in which video images of the rearward region are required, and displays these video images of the rearward region on the monitor 15.

Alternatively, when, for example, the navigation system 11 provides route guidance by setting a route for the present vehicle based on map data that is stored in the map data storage device, then it is also possible, if the route is one that requires a lane change or a fork or a merge, for the display switching device 18 to determine that a state exists in which video images of the rearward region are required and to display the video images of the rearward region on the monitor 15.

Moreover, it is also possible for a vehicle occupant to manually switch the images displayed on the monitor 15 by operating a selection switch (as not shown).

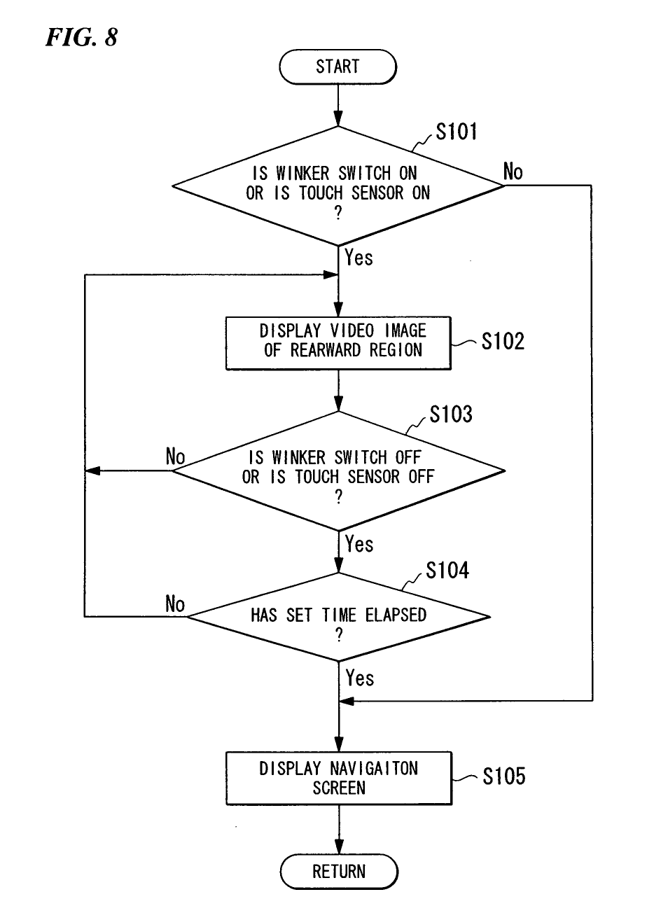

An example of a process for switching images based on the ON/OFF state of a winker switch or touch sensor will now be described below in accordance with the flow chart shown in FIG. 8.

Firstly, in step S101, it is determined whether or not the winker switch is ON, or whether or not the touch sensor is ON.

If the result of the determination in step S101 is “YES” (i.e., ON), then external video images (i.e., video images of the rearward region) are displayed on the monitor 15 in the next step S1102.

In the next step S103, it is determined whether or not the winker switch is OFF, or whether or not the touch sensor is OFF. If the result of this determination is “NO” (ON), the routine returns to step S102, and the display of the external video images (i.e., of the video images of the rearward) is continued.

If the result of the determination in step S103 is “YES” (OFF), then it is determined whether or not a fixed time has elapsed since the winker switch or touch sensor changed to OFF in the next step S104. If the result of this determination is “NO” (i.e., the fixed time has not elapsed), the routine returns to step S102, and the display of the external video images (i.e., of the video images of the rearward) is continued.

If the result of this determination in step S104 is “YES” (i.e., the fixed time has elapsed), then the navigation screen is displayed on the monitor 15 in the next step S105.

The navigation screen is also displayed in the subsequent step S105 when the result of the determination in step S101 is “NO” (OFF).

The door mirrors 16 may be, for example, aspherical mirrors that are formed such that the curvature changes continuously from the center portion of the mirror towards the outer circumferential portion thereof. In this case, compared with when, for example, a single spherical mirror is used, the viewing angle is increased by a factor of 1.4 to 1.7.

Note that the door mirror 16 on the driver's side (for example, the right door mirror 16R) is placed so as to be visible to a driver when the head turn angle of a driver facing forward is, for example, approximately 5°, while the door mirror 16 on the side away from the driver's side (for example, the left door mirror 16L) is placed so as to be visible to a driver when the head turn angle of a driver facing forward is, for example, approximately 30°.

The viewable range of the door mirror 16 is set so as to allow an region of the rearward of the present vehicle and an adjacent vehicle lane of the present vehicle (hereinafter, this region is referred to as an ‘region on the rearward of the present vehicle’) to be visible to a driver.

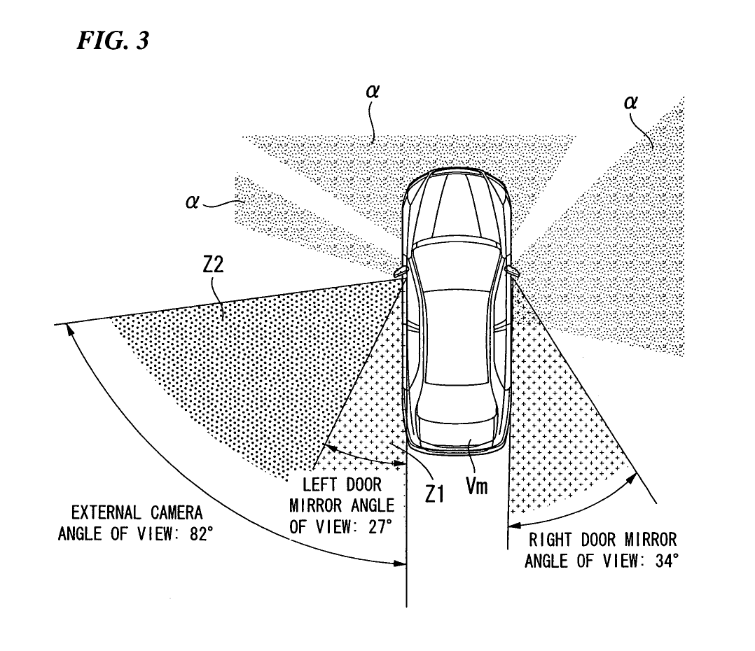

For example, as is shown in FIG. 3, the viewable range of the door mirror 16 on the driver's side (for example, the right door mirror 16R) is set, for example, at a viewing angle of 34° like in accordance with a predetermined eye point of the driver, in which the range that shows the present vehicle itself is set, for example, at a viewing angle of 1 to 2°.

Moreover, the viewable range of the door mirror 16 on the side away from the driver's side (for example, the left door mirror 16L) is set, for example, at a viewing angle of 27√ or the like in accordance with a predetermined eye point of the driver, in which the range that shows the present vehicle itself is set, for example, at a viewing angle of 1 to 2°.

Furthermore, an object detection range of the external camera 13 that is provided in the door mirror 16 on the side away from the driver's side (for example, the left door mirror 16L) is set, for example, at a viewing angle of 82° or the like so as to include an rearward region Z1 of the present vehicle, which can be viewed by a driver using the left door mirror 16L, and a dead angle region Z2 that is adjacent to the rearward region Z1 and is not able to be viewed by the driver using the left door mirror 16L. Of this object detection range of the external camera 13, the region that overlaps with the actual body of the present vehicle is set, for example, at a viewing angle of 1 to 2°.

Noted that, in FIG. 3, a predetermined viewable range α on the front side of the present vehicle is set so as to be visible to the driver, if the driver looks around while the line of sight of the driver is targeted on the monitor 15 or the door mirror 16.

An example of image processing by the aforementioned image processing device 17 will now be described below.

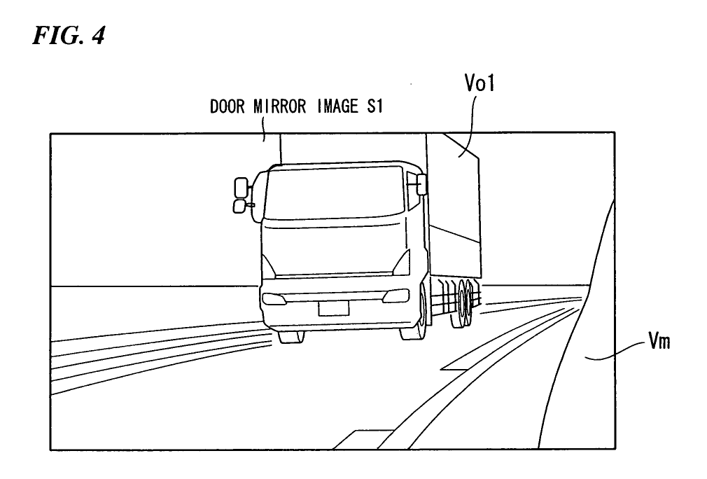

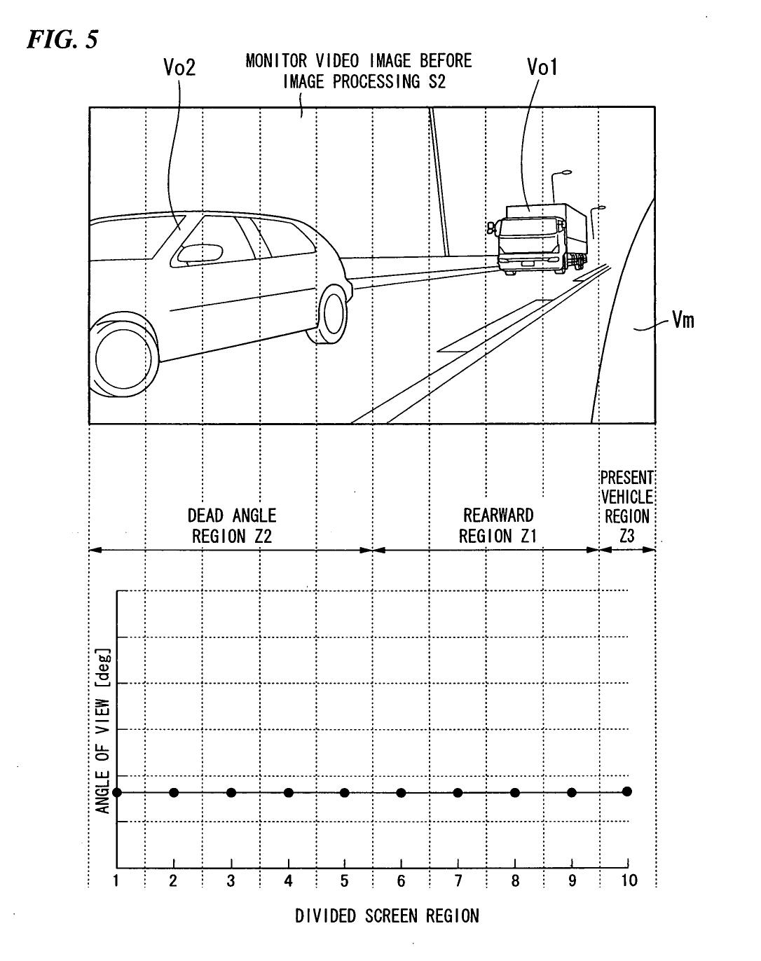

FIG. 4 shows an image S1 that is perceived by a driver when it is reflected in the left door mirror 16L, while the top drawing in FIG. 5 shows a video image S2 that is displayed on the monitor 15 with the raw image data photographed by the external camera 13 at the same time as the image S1 is photographed. Namely, the video image is displayed on the monitor 15 without performing image processing thereon by the image processing device 17 (hereinafter referred to as the ‘monitor video image before image processing S2’).

If the image S1 that is reflected in the left door mirror 16L is compared with the monitor video image before image processing S2, then a portion of the body of the present vehicle Vm and a first other vehicle Vo1 that is present in the rearward region Z1 and is traveling in the vehicle lane adjacent to the present vehicle are shown in both of the images S1 and S2. However, because the external camera 13 is photographing through a wide-angle lens, the image of the first other vehicle Vo1 that is displayed in the monitor video image before image processing S2 is considerably smaller than the image thereof that is reflected in the left door mirror 16L. Moreover, a second other vehicle Vo2 that is traveling in the dead angle region Z2 is only displayed in the monitor video image before image processing S2.

In this manner, the driver feels a sense of discomfort because the first other vehicle Vo1 appears to the driver at a large size in the left door mirror 16L while at a small size in the monitor 15 despite those images are of the identical vehicle that is present in the rearward region Z1. Furthermore, the driver finds it hard to obtain a true sense of the distance between the present vehicle and the first other vehicle Vo1, because the driver who has viewed the monitor 15 feels that the first other vehicle Vo1 is farther away than it actually is.

Therefore, in the driving support apparatus 10 of the present invention, image processing is performed to enlarge a predetermined region of the video image photographed by the camera 13, where the sense of distance for a driver is important (i.e., the rearward region Z1 in the present example), to substantially the same size as the image perceived by the driver in the left door mirror 16L, while, in contrast, image processing is performed to reduce the video image of the region where the sense of distance for the driver is not particularly important (i.e., the dead angle region Z2 in this example), and then outputs the image data to the display switching device 18.

This image processing will be described below in detail.

Firstly, the display region of the monitor 15 is divided in the vehicle width direction into a plurality of portions. As is shown in FIG. 5, in the present example, the display region is evenly divided in the vehicle width direction into 10 unit display regions. In the monitor video image before image processing S2, image data of the dead angle region Z2 is displayed in the first through fifth unit display regions starting from the left-hand side, while image data of the rearward region Z1 is displayed in the sixth through ninth unit display regions. Image data of a region (hereinafter referred to as the ‘present vehicle region Z3’) that includes a portion of the body of the present vehicle is displayed in the tenth unit display region.

As is shown in the bottom drawing in FIG. 5, in the monitor video image before image processing S2, the angle of view is uniform in all of the unit display regions. Image processing to alter the angle of view is performed by the image processing device 17.

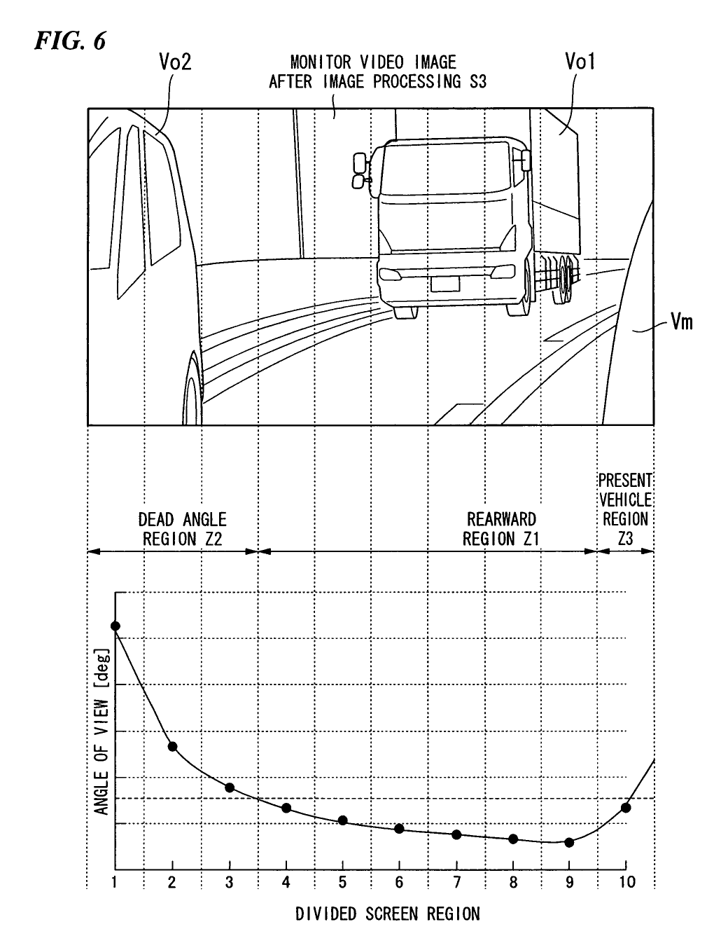

Specifically, image data of the rearward region Z1, from among the image data that is input from the camera 13, can be displayed in an enlarged form on the monitor 15 by decreasing the angle of view in each unit display region. As is shown in the top drawing in FIG. 6, the enlargement ratio of the image data is set so as to gradually increase the farther away it is from the image of the dead angle region Z2, and the size of the image of the first other vehicle Vo1 that is displayed on the monitor 15 is set so as to be substantially the same as the size of the image of the first other vehicle Vo1 that is perceived by the driver in the left door mirror 16L.

By increasing the angle of view in each of the unit display regions, the image data of the dead angle region Z2, from among the image data input from the camera 13, can be displayed in a reduced form in the vehicle width direction on the monitor 15. The reduction ratio of this image data is set so as to gradually decrease the closer it is to the image of the rearward region Z1. As a result, without losing the image data of the dead angle region Z2, it is possible to provide a display on the monitor 15 such that the driver recognizes that the second other vehicle Vo2 is present in the dead angle region Z2. In addition, it is possible to display on the monitor 15 image data in which the images of the dead angle region Z2 and the rearward region Z1 are smoothly connected.

Moreover, of the image data input from the camera 13, by setting the angle of view in the unit display region of the image data of the present vehicle region Z3 larger than the angle of view of the unit display regions of the rearward region Z1, the image data of the present vehicle region Z3 is displayed on the monitor 15 smaller in the vehicle width direction than the video images of the rearward region Z1. As a result, image data of the present vehicle region can be displayed on the monitor 15 without being lost.

Basically, the above-described image processing depends on altering the angle of view in each unit display region. In order for all of the unit display regions to be more smoothly connected on the monitor 15 even after the angle of view of the image data has been altered, the respective angles of view are set, as is shown in the bottom drawing in FIG. 6, so as to change continuously in a horizontal direction.

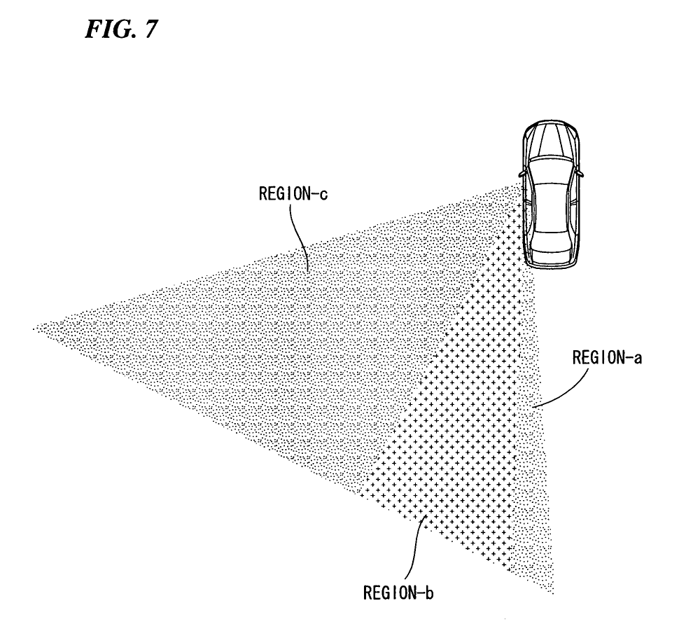

A relationship between the object detection regions of the external camera 13 and the angle of view of that is shown in FIG. 7. REGION-a shows the angle of view that is required to observe a body panel of the present vehicle, REGION-b shows the angle of view that is required to ascertain the presence of a vehicle in the rearward region, REGION-c shows the angle that is required to ascertain the presence of a vehicle in the dead angle region. In order to display information required by a driver more appropriately on the monitor, as is described above, by adjusting the angle of view of each unit display region making up a photographed video image, processing is performed, for example, to reduce those regions corresponding to REGION-a and enlarge those regions corresponding to REGION-b and REGION-c.

A video image displayed on the monitor 15 in which image data that has undergone image processing in the manner described above (hereinafter referred to as a ‘monitor video image after image processing S3’) is shown in the top drawing in FIG. 6. In the monitor video image after image processing S3, image data of the dead angle region Z2 is displayed in the first through third unit display regions starting from the left-hand side of the display region that has been divided into ten sections, while image data of the rearward region Z1 is displayed in the fourth through ninth unit display regions, and image data of the present vehicle region Z3 is displayed in the tenth unit display region.

In the monitor video image after image processing S3, the first other vehicle Vo1 that is present in the rearward region Z1 appears to be substantially the same size as the image of the first other vehicle Vo1 that is perceived by the driver in the left door mirror 16L. Accordingly, a driver feels no sense of discomfort when viewing the left door mirror 16L and the monitor 15, and the sense of distance from the present vehicle to the first other vehicle Vo1 appears substantially the same irrespective of whether the left door mirror 16L or the monitor 15 is viewed.

Moreover, in the monitor video image after image processing S3, although the second other vehicle Vo2 appears in a fairly compressed form in the left side of the monitor 15, it is still possible for a driver to perceive the second other vehicle Vo2 present in the dead angle of the left door mirror 16L.

Moreover, in the monitor video image after image processing S3, a portion of the body of the present vehicle Vm appears in the right side of the monitor 15 although in slightly compressed form. As a result, a driver is able to ascertain the relative positional relationship between the present vehicle Vm and the first other vehicle Vo1 or second other vehicle Vo2.

As has been described above, because it is possible, according to the driving support apparatus 10 of the present embodiment, to display on the monitor 15 an enlargement of an object such as another vehicle that is present in the rearward region Z1, a driver is able to reliably view this object through the monitor 15.

Moreover, because an object such as another vehicle that is present in the rearward region Z1 appears at substantially the same size in both the left side door mirror 16L and the monitor 15, a driver feels no sense of discomfort when viewing the left door mirror 16L and the monitor 15, and the sense of distance from the present vehicle to the object appears substantially the same irrespective of whether the left door mirror 16L or the monitor 15 is viewed. Accordingly, it is possible to perform a safety check of the rearward region with a greater degree of reliability.

Moreover, because a driver is able to view through the monitor 15 an object that is present in the dead angle region Z2 which the driver is not able to perceive using the door mirror 16L, it is possible to perform a safety check of the dead angle region with a large degree of reliability.

Furthermore, because a driver is able to view a portion of the body of the present vehicle through the monitor 15, it is possible to ascertain the relative positional relationship between the present vehicle and the object displayed on the monitor 15.

Note that this invention is not limited to the above-described embodiment.

For example, the display unit is not limited to the monitor of a navigation system, and it may also be formed by a display unit that is provided integrally with instruments displaying various traveling quantities of state or is placed adjacent to the various instruments, or a head-up display (HUD) that displays various information in the front window so as not to block the forward field of vision of the driver.

Moreover, in the above-described embodiment, the display region of the display unit is divided into 10 sections, and the display region where video images of the dead angle region are displayed, the display region where video images of the rearward region (i.e., a predetermined region) are displayed, and the display region where video images of the present vehicle region are displayed are provided in a ratio of 3:6:1. However, the number of sections into which the display region is divided is not limited to 10, and the ratio of the display regions is not limited to 3:6:1, and these may be set to an appropriate number of sections and an appropriate ratio.

The processing to enlarge or reduce the image data photographed by the camera may also be performed by arithmetic processing using a polynomial approximation function, such that a desired video image is obtained.

While a preferred embodiment of the invention has been described and illustrated above, it should be understood that this is exemplary of the invention and is not to be considered as limiting. Additions, omissions, substitutions, and other modifications can be made without departing from the spirit or scope of the present invention. Accordingly, the invention is not to be considered as limited by the foregoing description and is only limited by the scope of the appended claims.

What is claimed is:

1. A driving support apparatus comprising:
an image sensing device that is provided in a vehicle, and is able to photograph a rearward region of the vehicle, and a dead angle region that is adjacent to the rearward region and cannot be perceived by a driver with a side mirror; and
a display unit that displays video images photographed by the image sensing device so as to be visible to the driver, wherein
a predetermined region of the video image photographed by the image sensing device is displayed in an enlarged form.

2. The driving support apparatus according to claim 1, wherein
the predetermined region corresponds to the rearward region.

3. The driving support apparatus according to claim 1, wherein
an enlargement ratio of the predetermined region of the video image can be changed in each unit display region that makes up the video image.

4. The driving support apparatus according to claim 3, wherein
the enlargement ratio increases the farther away it is from the dead angle region.

5. The driving support apparatus according to claim 1, wherein
the display unit displays the dead angle region of the video image in a reduced form in the vehicle width direction.

6. The driving support apparatus according to claim 5, wherein
the reduction ratio of the dead angle region of the video image decreases the closer it is to the predetermined region.

7. The driving support apparatus according to claim 3, wherein
the enlargement ratio is set such that the size of an image of an object in the predetermined region displayed by the display unit is substantially the same as the size of an image of the object that is perceived by the driver in the side mirror.

8. The driving support apparatus according to claim 3, wherein
the image sensing device is able to photograph a region that includes a portion of a body of the vehicle, and
the display unit displays a video image such that an enlargement ratio of the region that includes the portion of the vehicle body is smaller than the enlargement ratio of the predetermined region in the vehicle width direction.
